(19) United States
(12) Patent Application Publication
(10) Pub. No.: US 2004/0218381 A1
(43) Pub. Date: Nov. 4, 2004

(54) Safety devices that include a body having a light disposed thereon and are configured to be carried on a base

(76) Inventors: Charlie Sawyer, Orlando, FL (US); Isaac D. White, Orlando, FL (US); James E. Dickens, Ocoee, FL (US); Blake R. Urban, Lenoir, NC (US); Kevin Forsberg, Orlando, FL (US)

Correspondence Address: MYERS BIGEL SIBLEY & SAJOVEC, P.A., P.O. BOX 37428, RALEIGH, NC, 27627, US

(21) Appl. No.: 10/429,152

(22) Filed: May 2, 2003

(51) Int. Cl. F21L 2/00

(52) U.S. Cl. 362/157

(57) ABSTRACT

A safety device includes a base portion and a body portion. The body includes a power source and has an opening at a first end thereof. The opening in the body is configured to receive the end of the base such that the base carries the body thereon. A light is disposed on the body and is configured to receive power from the power source. The body with the lights disposed thereon may be used to enhance the effectiveness of the base as a safety device. The lights may be particularly effective as a warning mechanism in low light conditions or when the color of the base tends to blend in to the surrounding environment.

### BACKGROUND OF THE INVENTION

The present invention relates to safety devices, and, more particularly, to safety devices that incorporate lights as a warning element.

Safety devices are often used to control or direct traffic. These safety devices, such as brightly colored cones, flags, and/or barrels, may be used to alert passing motorists and/or pedestrians to be aware of abnormal conditions. For example, such safety devices are frequently used to direct traffic around an accident scene, a stopped/disabled vehicle, and/or a construction site. Utility repair crews often use safety devices to define a perimeter around a repair vehicle and/or a work site to warn members of the public to stay away from the repair vehicle and/or work site to avoid potential injury. To enhance their warning effect, safety devices are typically brightly colored. Unfortunately, such devices may still be difficult to see depending on, for example, such factors as the time of day, the time of the year, the weather, and/or the surrounding environment.

### SUMMARY OF THE INVENTION

According to some embodiments of the present invention, a safety device comprises a base portion and a body portion. The body comprises a power source and has an opening at a first end thereof. The opening in the body is configured to receive the end of the base such that the base carries the body thereon. A light is disposed on the body and is configured to receive power from the power source. The body with the lights disposed thereon may be used to enhance the effectiveness of the base as a safety device. The lights may be particularly effective as a warning mechanism in low light conditions or when the color of the base tends to blend in to the surrounding environment.

In other embodiments of the present invention, the base is a cone.

In still other embodiments of the present invention, the light is disposed on the body between the first end of the body and the second end of the body.

In still other embodiments of the present invention, the light is disposed on the body at a second end of the body, opposite the end with the opening.

In still other embodiments of the present invention, the light is a strobe light.

In further embodiments of the present invention, the base comprises a standard.

In still further embodiments of the present invention, the standard comprises a first section and a second section such that the second section is movable in relation to the first section so as to adjust a length of the standard.

In still further embodiments of the present invention, the base further comprises a mount that is configured to support the standard.

In still further embodiments of the present invention, the mount comprises a magnet.

In other embodiments of the present invention, the power source may be a batter and/or a solar cell.

### BRIEF DESCRIPTION OF THE DRAWINGS

Other features of the present invention will be more readily understood from the following detailed description of specific embodiments thereof when read in conjunction with the accompanying drawings, in which:

FIG. 1A is an exploded perspective view of a safety device in accordance with some embodiments of the present invention;

FIG. 1B is a perspective view of a body for use in a safety device in accordance with some embodiments of the present invention;

FIG. 2 is a base for use in a safety device in accordance with some embodiments of the present invention;

FIG. 3 is an exploded perspective view of a telescopic base for use in a safety device in accordance with some embodiments of the present invention; and

FIG. 4 is a front view of a base for use in a safety device in accordance with some embodiments of the present invention.

### DETAILED DESCRIPTION OF PREFERRED EMBODIMENTS

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It will also be understood that when an element is referred to as being “connected” or “coupled” to another element, it can be directly connected or coupled to the other element or intervening elements may also be present. In contrast, when an element is referred to as being “directly connected” or “directly coupled” to another element, there are no intervening elements present.

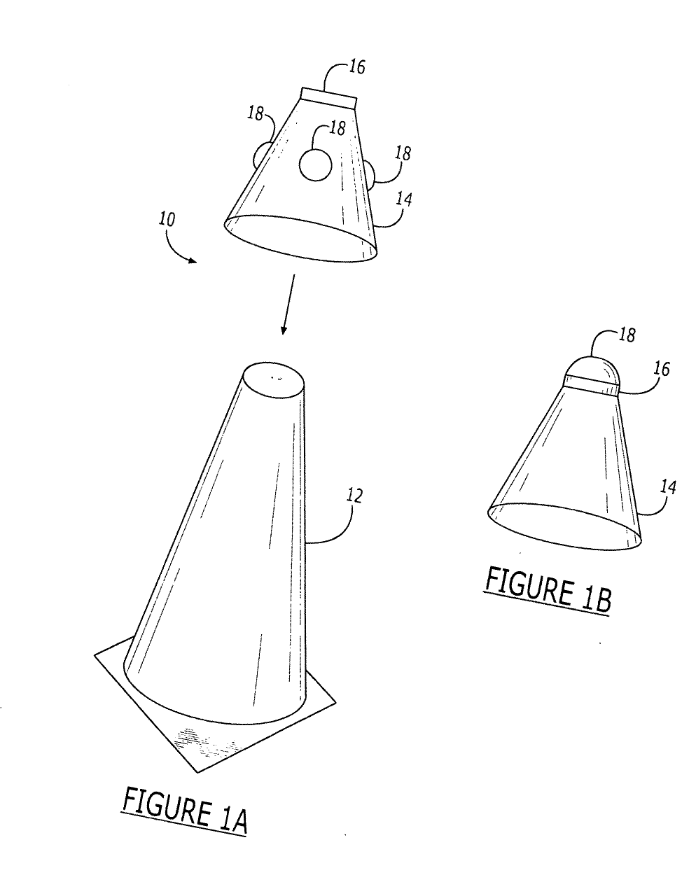

Referring now to FIG. 1A, a safety device 10, in accordance with some embodiments of the present invention, is illustrated. The safety device 10 comprises a base 12 and a body 14. As shown in FIG. 1A, the base 12 has a general frustoconical shape and may be, for example, a conventional traffic cone used to direct vehicular and/or pedestrian traffic around a work site. The body 14 also has a general frustoconical shape and has an opening at an end thereof to allow the base 12 to receive the body 14 over the end so as to carry the body 14 thereon. The body 14 comprises a power source 16, which may comprise a battery and/or solar cell, for example, that provides power to one or more lights 18 that are disposed on the body 14. The lights 18 may be configured to shine intermittently or configured to shine continuously. The lights 18 may be disposed on the sides of the body 14 as shown in FIG. 1A and/or, as shown in FIG. 1B, a light 18 may be disposed at an end of the body 14. Advantageously, the body 14 with the lights 18 disposed thereon may be used to enhance the effectiveness of the base 12 as a safety device. The lights 18 may be particularly effective as a warning mechanism in low light conditions or when the color of the base tends to blend in to the surrounding environment. In some embodiments, the body 14 may comprise a polymer, such as a plastic material. In other embodiments, the body may comprise a metal, such as aluminum and/or steel.

Although the safety device 10 has been described above in the context of the base 12 and body 14 having a generally frustoconical shape, it will be understood that the present invention is not limited to any particular shape or configuration. In general, the base 12 may assume any shape that facilitates reception of a body 14 thereon via an opening contained in the body 14. Other examples of base units that may be used in safety devices, in accordance with some embodiments of the present invention, will be described hereafter.

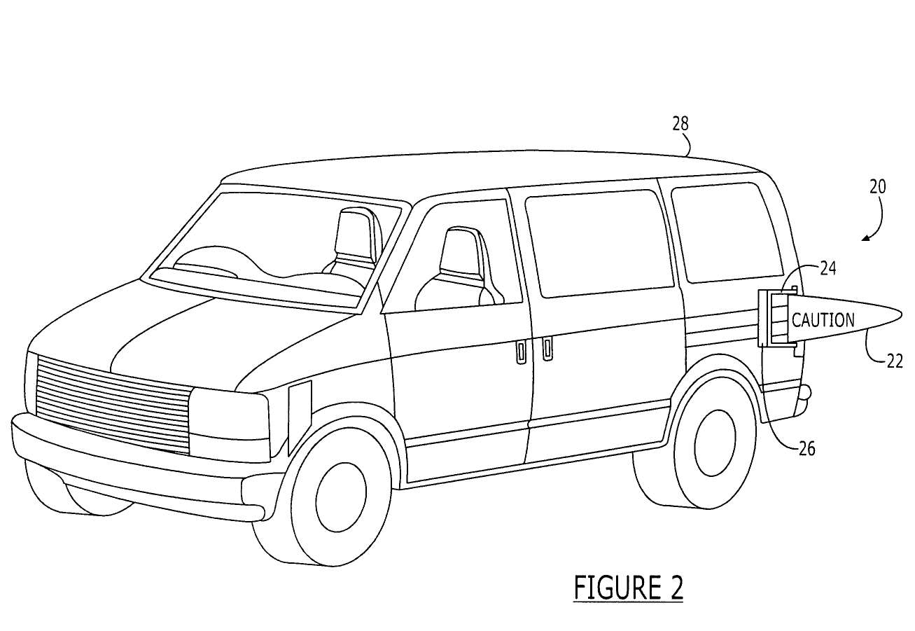

Referring now to FIG. 2, a base 20, in accordance with some embodiments of the present invention, comprises a generally rigid standard 22 that extends from a mount 24. As shown in FIG. 2, the standard 22 may have a pennant shape, but, as discussed above, the standard 22 may have any shape that facilitates reception of a body, such as the body 14 of FIGS. 1A and 1B, thereon. The mount may comprise a magnet 26 to facilitate attachment of the base 20 to a metal structure, such as a vehicle 28.

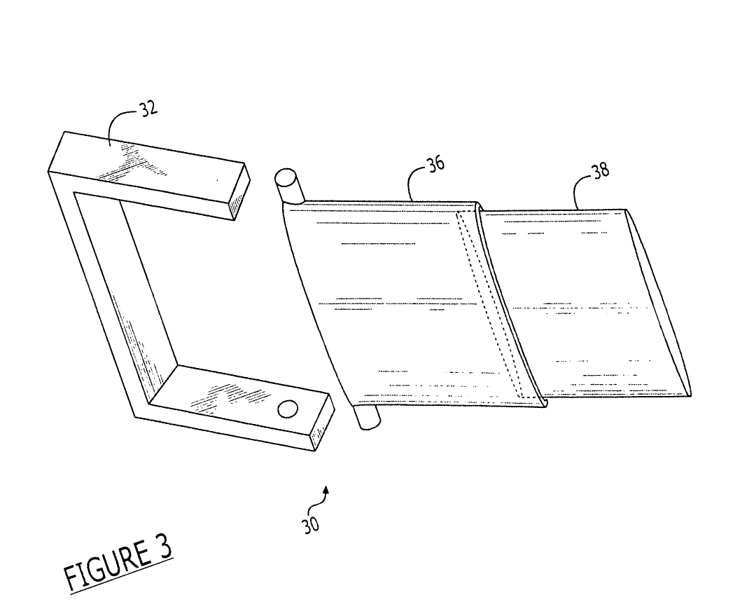

Referring now to FIG. 3, a base 30, in accordance with some embodiments of the present invention, comprises a mount 32 that is configured to receive the standard 34. The standard 34 comprises a first section 36 and a second section 38. As shown in FIG. 3, the second section 38 is configured to translate relative to the first section 36 to allow the standard 34 to extend and retract telescopically to adjust the length of the standard 34 to a desired length.

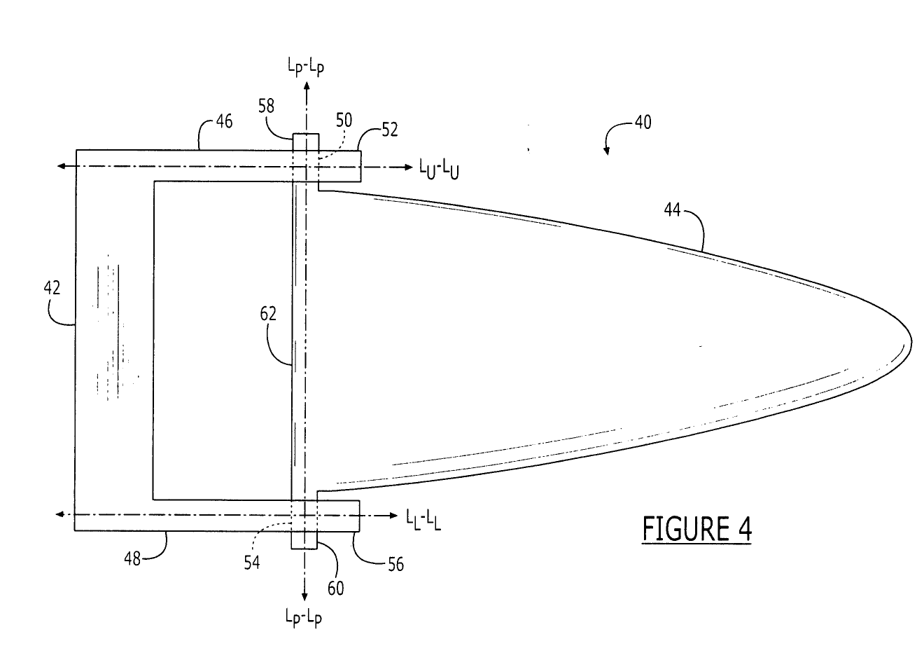

Referring now to FIG. 4, an exemplary configuration of a base 40, in accordance with some embodiments of the present invention, is shown. The base 40 comprises a mount 42 and a standard 44. As shown in FIG. 4, the mount 42 is generally “C-shaped.” It will be understood, however, that the mount 42 may have any shape that is suitable for the corresponding standard. The mount 42 comprises an upper support member 46 and a lower support member 48. The upper support member 46 has an elongate shape that defines an upper longitudinal axis L_{U}-L_{U}. The upper support member 46 includes an aperture 50 near a distal end 52. The aperture 50 may be aligned along the upper longitudinal axis L_{U}-L_{U}. The lower support member 48 also has an elongate shape that defines a lower longitudinal axis L_{L}-L_{L}. The lower support member 48 includes an aperture 54 near a distal end 56. The aperture 54 may be aligned along the lower longitudinal axis L_{L}-L_{L}. The standard 44 comprises an upper pin 58 and a lower pin 60 at a common end 62 of the standard 44. The upper pin 58 and the lower pin 60 may be aligned along a pivot axis L_{P}-L_{P}. The upper pin 58 is configured to insert into the aperture 50 in the upper support member 46 and the lower pin 60 is configured to insert into the aperture 54 in the lower support member 48. The upper pin 58 and the lower pin 60 may be configured to rotate within apertures 50 and 54, respectively, to allow the standard 44 to pivot about the axis L_{P}-L_{P}.

Many variations and modifications can be made to the preferred embodiments without substantially departing from the principles of the present invention. All such variations and modifications are intended to be included herein within the scope of the present invention, as set forth in the following claims.

1. A safety device, comprising:
a base having an end and comprising a first section and a second section, the second section being translatable in relation to the first section so as to adjust a length of the base;
a body having an opening at a first end thereof and comprising a power source, the opening of the body being configured to receive the end of the base such that the base carries the body thereon; and
a light disposed on the body and being configured to receive power from the power source.

2. The safety device of claim 1, wherein the base has a generally frustoconical shape.

3. The safety device of claim 1, wherein the light is disposed on the body between the first end of the body and a second end of the body.

4. The safety device of claim 1, wherein the light is disposed on the body at a second end thereof.

5. The safety device of claim 1, wherein the light is configured to shine intermittently.

6. (Canceled)

7. (Canceled)

8. The safety device of claim 1, further comprising a mount that is configured to support the base.

9. The safety device of claim 8, wherein the mount comprises a magnet.

10. The safety device of claim 1, wherein the power source is a battery.

11. The safety device of claim 1, wherein the power source is a solar cell.

12. A safety device, comprising:
a base having an end;
a body having an opening at a first end thereof and comprising a power source, the opening of the body being configured to receive the end of the base such that the base carries the body thereon; and
a light disposed on the body at a second end thereof that is opposite the first end and being configured to receive power from the power source.

13. (Canceled)

14. (Canceled)

15. The safety device of claim 12, wherein the light is configured to shine intermittently.

16. The safety device of claim 12, wherein the power source is a battery.

17. The safety device of claim 12, wherein the power source is a solar cell.

18. A safety device, comprising:
a flag-shaped standard having a tapered end;
a body having an opening at a first end thereof and comprising a power source, the opening of the body being configured to receive the end of the standard such that the standard carries the body thereon; and
a light disposed on the body and being configured to receive power from the power source.

19. The safety device of claim 18, wherein the light is disposed on the body between the first end of the body and a second end of the body.

20. The safety device of claim 18 wherein the light is disposed on the body at a second end thereof.

21. The safety device of claim 18, wherein the light is configured to shine intermittently.

22. The safety device of claim 18, wherein the standard comprises a first section and a second section, the second section being translatable in relation to the first section so as to adjust a length of the standard.

23. The safety device of claim 18, further comprising a mount that is configured to support the standard.

24. The safety device of claim 23, wherein the mount comprises a magnet.

25. The safety device of claim 18, wherein the power source is a battery.

26. The safety device of claim 18, wherein the power source is a solar cell.
